(19) United States
(12) Patent Application Publication
(10) Pub. No.: US 2009/0040631 A1
(43) Pub. Date: Feb. 12, 2009

(54) LENS BARREL AND METHOD FOR MANUFACTURING SAME

(75) Inventor: HANG-MING WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/184,936

(22) Filed: Aug. 1, 2008

(30) Foreign Application Priority Data
Aug. 10, 2007 (CN) 200710201339.8

(51) Int. Cl. G02B 7/02; B65H 81/00

(52) U.S. Cl. 359/811; 156/184

(57) ABSTRACT

A lens barrel includes an inner metal barrel, and an outer plastic barrel. The inner metal barrel has a number of concentric annular steps formed in an inner surface thereof. The outer plastic barrel encloses the inner metal barrel therein. The inner metal barrel is integrated with the outer plastic barrel using an insert molding process.

### BACKGROUND

1. Technical Field

The invention relates to lens barrels of lens modules and, particularly to a lens barrel defining steps in the inner surface thereof and a method for manufacturing the same.

2. Description of the Related Art

In general, a lens module includes a lens barrel and a number of lenses. The lenses are received within the lens barrel. The lens barrel is typically made of plastic materials via injection molding to meet requirements of industry production, e.g., low cost and/or high output. The lens barrel commonly defines a number of steps in the inner surface thereof. These steps are for receiving the lenses and are strictly coaxial with the lens barrel to ensure the lenses received thereby are rigorously coaxial with the lens barrel. One of the challenges of manufacturing such a lens barrel is that due to the thermal properties of plastic materials, the lens barrel contracts and may deform when cooled during the injection molding process. As a result, the coaxality between the lens barrel and the lenses suffers.

Therefore, it is desirable to provide a lens barrel defining steps in the inner surface thereof and a method for manufacturing the same, which can overcome the above mentioned problem.

### SUMMARY

In an exemplary embodiment, a barrel includes an inner metal barrel, and an outer plastic barrel. The inner metal barrel has a number of concentric annular steps formed in an inner surface thereof. The outer plastic barrel encloses the inner metal barrel therein. The inner metal barrel is integrated with the outer plastic barrel using an insert molding process.

### BRIEF DESCRIPTION OF THE DRAWINGS

FIG. 1 is schematic, cross-sectional view of a lens barrel, according to an exemplary embodiment.

FIG. 2 is a flow chart of a method for manufacturing a lens barrel, according to another embodiment.

FIG. 3 is a schematic, cross-sectional view showing how the method of FIG. 2 is carries out.

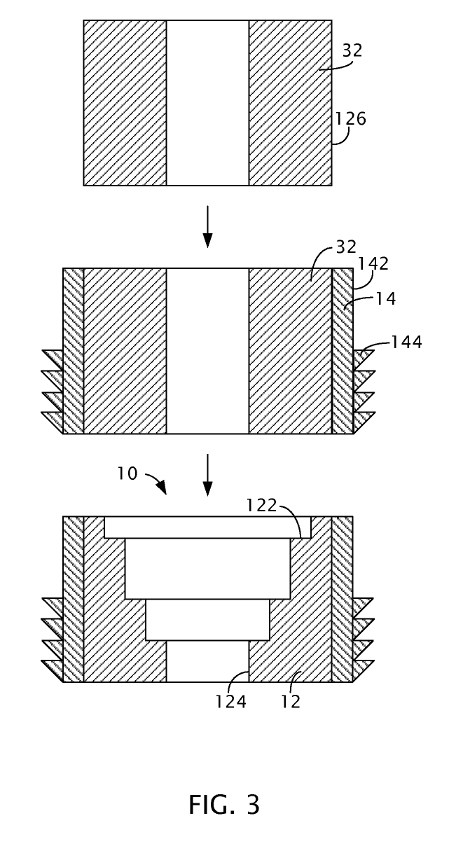

### DETAILED DESCRIPTION OF THE EMBODIMENTS

Embodiments of the present lens barrel and method for manufacturing the same will now be described in detail with references to the accompanying drawings.

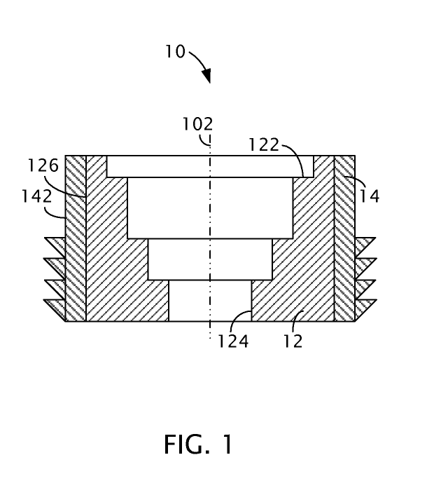

Referring to FIG. 1, a lens barrel 10, according to an exemplary embodiment, includes an inner metal barrel 12 and an outer plastic barrel 14. The inner metal barrel 12 is tubular in shape and defines three substantially concentric steps 122 in the inner surface 124 thereof, and is wrapped by the outer plastic barrel 14. The steps 122 are substantially coaxial with the inner metal barrel 12. Thereby, the inner metal barrel 12 and the steps 122 define an optical axis 102 of the lens barrel 10.

The inner metal barrel 12 is roughly tubular in shape, and can be made from any of the following materials: copper, aluminum, iron, nickel, titanium, steel, carbon steel, stainless steel, and any alloy of copper, aluminum, iron, nickel, titanium. In this embodiment, the inner metal barrel 12 is made from copper alloy.

The steps 122 can be formed by precision machining. In this embodiment, the steps 122 are formed by coaxial machining with computer numerical control (CNC) machine. Coaxiality between the inner metal barrel 12 and the steps 122 can be controlled by the CNC machine. As a result, the coaxality between the lens barrel 10 and the steps 122 is set to be smaller than 5 microns. However, coaxiality between the lens barrel and the steps of plastic lens barrel made by injection molding is approximately 5 to 15 microns. In addition, coaxalities of lens barrels of plastic lens barrel made by plastic injection molding mostly depend on manufacture conditions, such as temperature and/or pressure, and therefore may be greatly different from each other. In all, coaxality between the lens barrel 10 and the steps 122 is more readily controlled and more stable as compared with conventional plastic lens barrels that are made by plastic injection molding. Therefore, coaxality between the lens barrel 10 and lenses (not shown) received thereby is assured.

It should be understood that, the number of the steps 122 is not limited by this embodiment.

The outer plastic barrel 14 can be formed with the inner metal barrel 12 using a variety of methods such as insert molding.

Optionally, the outer surface 126 of the inner metal barrel 12 can be applied with various surface treatments to increase roughness thereof. Thereby, the outer plastic barrel 14 can grasp the inner metal barrel 12 more tightly, avoiding separation therebetween. The outer surface 142 of the outer plastic barrel 14 may be threaded. Thereby, the lens barrel 10 can be coupled to lens holder (not shown) via threads.

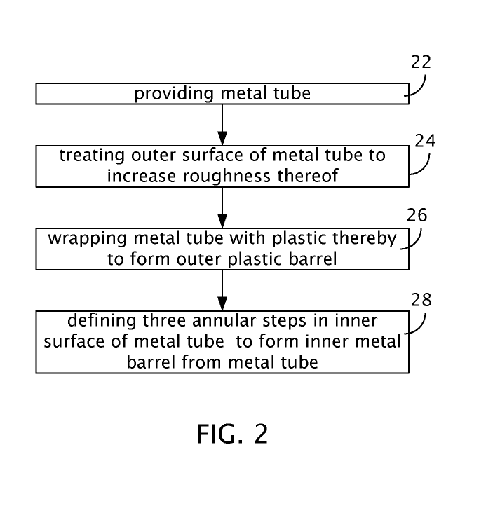

Referring to FIG. 2, a method for manufacturing the lens barrel 10, according to another embodiment, includes the following operations 22˜28.

Operation 22: providing a metal tube 32.

Operation 24: treating the outer surface 126 of the metal tube 32 to increase roughness thereof.

Operation 26: wrapping the metal tube 32 with plastic, thereby forming the outer plastic barrel 14 which wraps the metal tube 32. This can be achieved by insert molding. The outer plastic barrel 14 may include a threaded section 144 on the outer surface 142 thereof.

Operation 28: defining three substantially concentric steps 122 in the inner surface 124 to form the inner metal barrel 12. The steps 122 are substantially coaxial with the inner metal barrel 12. This can be achieved by coaxial machining with CNC machine. Thereby, the lens barrel 10 is obtained.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A lens barrel comprising:
an inner metal barrel having a plurality of annular steps in an inner surface thereof; and
an outer plastic barrel wrapping the inner metal barrel therein.

2. The lens barrel as claimed in claim 1, wherein the inner metal barrel is made from material selected from the group consisting of: copper, aluminum, iron, nickel, titanium, steel, carbon steel, and stainless steel.

3. The lens barrel as claimed in claim 1, wherein the inner metal barrel is made from alloy of at least two metals selected from the group consisting of: copper, aluminum, iron, nickel, and titanium.

4. The lens barrel as claimed in claim 1, wherein the steps are formed using precision machining process.

5. The lens barrel as claimed in claim 1, wherein the steps are formed using coaxial machining process with computer numerical control machine.

6. The lens barrel as claimed in claim 1, wherein the outer metal barrel is formed by insert molding.

7. The lens barrel as claimed in claim 1, wherein the outer surface of the inner metal barrel is treated to increase roughness thereof.

8. The lens barrel as claimed in claim 1, wherein the outer surface of the outer plastic barrel is threaded.

9. A method for manufacturing a lens barrel, comprising:
proving a metal tube;
wrapping the metal tube with plastic; and
defining a plurality of annular steps in the inner surface of the metal tube, the annular steps being coaxial with the metal tube.

10. The method as claimed in claim 9, further comprising: treating the outer surface of the metal tube to increase roughness thereof before wrapped.

11. The method as claimed in claim 9, wherein the metal tube is made from material selected from the group consisting of: copper, aluminum, iron, nickel, titanium, steel, carbon steel, and stainless steel.

12. The method as claimed in claim 9, wherein the metal tube is made from alloy of at least two metals selected from the group consisting of: copper, aluminum, iron, nickel, and titanium.

13. The method as claimed in claim 9, wherein the metal tube is wrapped with plastic using by insert molding.

14. The method as claimed in claim 9, wherein the outer surface of the plastic wrapping the metal tube is threaded.

15. The method as claimed in claim 9, wherein the steps are formed using precision machining process.

16. The method as claimed in claim 9, wherein the steps are formed using coaxial machining process with computer numerical control machine.

17. A lens barrel comprising:
an inner metal barrel having a plurality of concentric annular steps formed in an inner surface thereof; and
an outer plastic barrel enclosing the inner metal barrel therein, the inner metal barrel being integrated with the outer plastic barrel using an insert molding process.

18. The lens barrel as claimed in claim 17, wherein the outer plastic barrel has a threaded outer surface.
